(19) United States
(12) Patent Application Publication
(10) Pub. No.: US 2013/0230648 A1
(43) Pub. Date: Sep. 5, 2013

(54) KIT OF PARTS FOR CURABLE COATING COMPOSITION

(71) Applicants: Keimpe Jan Van Den Berg, Sassenheim (NL); Marcella Gagliardo, Castricum (NL); Robert Pieter Lagendijk, Valkenburg (NL)

(72) Inventors: Keimpe Jan Van Den Berg, Sassenheim (NL); Marcella Gagliardo, Castricum (NL); Robert Pieter Lagendijk, Valkenburg (NL)

(73) Assignee: AKZO NOBEL COATINGS INTERNATIONAL B.V., ARNHEM (NL)

(21) Appl. No.: 13/825,734

(22) PCT Filed: Sep. 27, 2011
(86) PCT No.: PCT/EP2011/066699

§ 371 Date: Mar. 22, 2013

Related U.S. Application Data
(60) Provisional application No. 61/388,805, filed on Oct. 1, 2010.

(30) Foreign Application Priority Data
Sep. 30, 2010 (EP) 10184026.2

(51) Int. Cl. C09D 167/04

(52) U.S. Cl. CPC C09D 167/04
USPC 427/160; 524/513; 522/14

(57) ABSTRACT

The invention relates to a kit of parts for preparation of a crosslinkable coating composition comprising a) a binder module comprising a film-forming binder comprising crosslinkable functional groups A, b) a crosslinker module comprising a crosslinker comprising at least two functional groups B capable of reacting with the crosslinkable functional groups A of the binder, c) a thermal activator module comprising one or more components which exhibit an accelerating effect on the reaction between functional groups A and B of the mixture of the binder module and the crosslinker module, d) an ultraviolet activator module comprising one or more components which after irradiation with ultraviolet light exhibit a greater accelerating effect on the reaction between functional groups A and B of the mixture of the binder module and the crosslinker module than before irradiation with ultraviolet light.

The invention relates to a kit of parts for preparation of a dual curable coating composition and to a process of preparing a coating composition from the kit of parts.

U.S. Pat. No. 6,579,913 describes a photoactivatable coating composition comprising at least one photoinitiator and a base-catalyzed polymerizable or curable organic material comprising at least one polyisocyanate and at least one compound comprising isocyanate-reactive groups. The coating compositions can be cured by UV radiation and have an acceptable curing speed at ambient temperature in places which are not readily accessible to UV light. It is further described that a major drawback of known dual cure coating compositions is the simultaneous presence of at least two entirely different curing mechanisms. One mechanism is based on the reaction between a multifunctional alkene and a multifunctional thiol, which requires UV radiation, whereas the secondary cure comprises a great many mechanisms such as the reaction of free isocyanate with water and the reaction of free isocyanate with the thiol component. One effect of such dual cure system is that unexposed places will only be cured in part, resulting in an unreacted amount of alkene in the unexposed places. Therefore, in order to still achieve a minimum degree of curing in these places, use will have to be made of compounds having a higher functionality. Using such compounds has a viscosity-increasing effect, which leads to a greater quantity of solvent being required to achieve a similar spraying viscosity, which is attended with an increase in the volatile solvent requirement.

WO 2007/068683 describes a composition comprising pentaerythritol tetrakis(3-mercapto propionate), a thiol-functional polyester having also hydroxyl groups, a polyisocyanate, and dibutyl tin dilaurate, and a photolatent base.

It is not disclosed in this document to provide the components of the composition as a kit of parts. The composition requires irradiation with ultraviolet light to achieve fast curing. Hence, it is not possible fully adapt the curing conditions to the needs of a user.

There is a need for thermally and/or ultraviolet curable coating compositions which can be prepared from the same binder and crosslinker modules, and which give coatings having the same final properties independent of the type of trigger which was used to initiate crosslinking. It is desirable that the curing conditions can be adapted to the needs of the specific user using a limited amount of modules.

The invention now provides a kit of parts for preparation of a crosslinkable coating composition comprising
a) a binder module comprising a film-forming binder comprising crosslinkable functional groups A,
b) a crosslinker module comprising a crosslinker comprising at least two functional groups B capable of reacting with the crosslinkable functional groups A of the binder, and wherein the functional groups A and B are not the same,
c) a thermal activator module comprising one or more components which, optionally upon heating, exhibit an accelerating effect on the reaction between functional groups A and B of the mixture of the binder module and the crosslinker module, and which after irradiation with ultraviolet light do not exhibit a greater accelerating effect on the reaction between functional groups A and B than before irradiation with ultraviolet light,
d) an ultraviolet activator module comprising one or more components which after irradiation with ultraviolet light exhibit a greater accelerating effect on the reaction between functional groups A and B of the mixture of the binder module and the crosslinker module than before irradiation with ultraviolet light.

From the kit of parts it is possible to prepare curable coating compositions which can be triggered to cure either thermally or by ultraviolet light, depending on the type of activator module used. It is also possible to prepare coating composition which can be cured thermally and by ultraviolet radiation. Hence, the curing conditions can be adapted to the needs of the specific user, such as the available equipment or the specific paint job. A further advantage is that the polymer network formed during curing of the coatings is the same for thermal curing and ultraviolet light curing. Hence, the final coating properties can be reliably achieved in any instance.

The coating composition prepared from the kit of parts generally is a liquid coating composition. The coating composition may be free of volatile liquid diluents. Alternatively, the coating composition comprises water or one or more organic solvents as volatile liquid diluents.

The binder module a) comprises a film-forming binder comprising crosslinkable functional groups A. The film-forming binder generally is an organic resin, an oligomer or polymer. Examples of suitable oligomers and polymers include polyesters, polyacrylates, polycarbonates, and polyurethanes, and mixtures thereof. The film-forming binder comprises crosslinkable functional groups A. Examples of suitable functional groups include hydroxyl groups, primary amine groups, secondary amine groups, epoxide groups, carboxylic acid groups, acryloyl groups, and thiol groups. The film-forming binder may also comprise more than one type of crosslinkable functional group.

The film-forming binder suitably has between 2 and 25 crosslinkable functional groups A per molecule. Hydroxyl groups are preferred crosslinkable functional groups.

The binder module may, in addition to the film-forming binder mentioned above, comprise other ingredients, additives or auxiliaries commonly used in coating compositions, such as pigments, dyes, surfactants, pigment dispersion aids, levelling agents, wetting agents, anti-cratering agents, antifoaming agents, antisagging agents, heat stabilizers, light stabilizers, UV absorbers, antioxidants, and fillers.

When the coating composition is an aqueous coating composition, the binder module suitable comprises water as volatile diluent, optionally in combination with one or more organic co-solvents. For organic solvent based coating compositions, the binder module suitable comprises one or more volatile organic diluents. Examples of suitable volatile organic diluents are hydrocarbons, such as toluene, xylene, Solvesso 100, ketones, terpenes, such as dipentene or pine oil, halogenated hydrocarbons, such as dichloromethane, ethers, such as ethylene glycol dimethyl ether, esters, such as ethyl acetate, ethyl propionate, n-butyl acetate or ether esters, such as methoxypropyl acetate or ethoxyethyl propionate. Also mixtures of these compounds can be used.

If so desired, it is possible to include one or more so-called “exempt solvents” in the coating composition. An exempt solvent is a volatile organic compound that does not participate in an atmospheric photochemical reaction to form smog. It can be an organic solvent, but it takes so long to react with nitrogen oxides in the presence of sunlight that the Environmental Protection Agency of the United States of America considers its reactivity to be negligible. Examples of exempt solvents that are approved for use in paints and coatings include acetone, methyl acetate, parachlorobenzotrifluoride (commercially available under the name Oxsol 100), and volatile methyl siloxanes. Also tertiary butyl acetate is considered to be an exempt solvent.

In one embodiment, the binder module also comprises a blocked, i.e. essentially deactivated catalyst for the crosslinking reaction between the functional groups A of the binder module and the functional groups B of the crosslinker module. Examples of deactivated catalysts are combinations of metal based catalysts and thiol-functional compounds. Suitable metals in the metal based catalyst include zinc, cobalt, manganese, zirconium, bismuth, and tin. It is preferred that the coating composition comprises a tin based catalyst. Well-known examples of tin based catalysts are dimethyl tin dilaurate, dimethyl tin diversatate, dimethyl tin dioleate, dibutyl tin dilaurate, dioctyl tin dilaurate, and tin octoate.

Suitable thiol-functional compounds to deactivate the metal catalyst include dodecyl mercaptan, mercapto ethanol, 1,3-propanedithiol, 1,6-hexanedithiol, methylthioglycolate, 2-mercaptoacetic acid, mercaptosuccinic acid, and cysteine. Also suitable are esters of a thiol-functional carboxylic acid with a polyol, such as esters of 2-mercaptoacetic acid, 3-mercaptopropionic acid, 2-mercaptopropionic acid, 11-mercaptoundecanoic acid, and mercaptosuccinic acid. Examples of such esters include pentaerythritol tetrakis (3-mercaptopropionate), pentaerythritol tetrakis (2-mercaptoacetate), trimethylol propane tris (3-mercaptopropionate), trimethylol propane tris (2-mercaptopropionate), and trimethylol propane tris (2-mercaptoacetate).

The use of a metal based deactivated catalyst in the binder module is particularly preferred in embodiments wherein the functional groups A are hydroxyl groups.

The crosslinker module comprises a crosslinker comprising at least two functional groups B capable of reacting with the crosslinkable functional groups A of the binder, with the proviso that the functional groups A and B are not the same. The type of functional groups B of the crosslinker depends on the type of functional groups A in the binder module.

Examples of suitable functional group combinations A and B include:

| A | B |
|---|---|
| Hydroxyl | Isocyanate |
| Primary amine | Isocyanate |
| Primary amine | Acryloyl |
| Secondary amine | Isocyanate |
| Secondary amine | Acryloyl |
| Epoxide | Carboxylic acid |
| Epoxide | Amine |
| Epoxide | Hydroxyl |
| Carboxylic acid | Epoxide |
| Acryloyl | Primary amine |
| Acryloyl | Thiol |
| Acryloyl | C-H acidic groups |
| Thiol | Isocyanate |
| Thiol | Ethylenic unsaturation |

In a preferred embodiment, the functional groups B in the crosslinker module are isocyanate groups. Suitable isocyanate-functional crosslinkers for use in the crosslinker module are isocyanate-functional compounds comprising at least two isocyanate groups. Preferably, the isocyanate-functional crosslinker is a polyisocyanate, such as an aliphatic, cycloaliphatic or aromatic di-, tri- or tetra-isocyanate. Examples of diisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, dodecamethylene diisocyanate, ω,ω′-dipropylether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexyl methane-4,4′-diisocyanate (Desmodur® W), toluene diisocyanate, 1,3-bis(isocyanatomethyl) benzene, xylylene diisocyanate, α,α,α′,α′-tetramethyl xylylene diisocyanate (TMXDI®), 1,5-dimethyl-2,4-bis(2-isocyanatoethyl) benzene, 1,3,5-triethyl-2,4-bis(isocyanatomethyl) benzene, 4,4′-diisocyanato-diphenyl, 3,3′-dichloro-4,4′-diisocyanato-diphenyl, 3,3′-diphenyl-4,4′-diisocyanato-diphenyl, 3,3′-dimethoxy-4,4′-diisocyanato-diphenyl, 4,4′-diisocyanato-diphenylmethane, 3,3′-dimethyl-4,4′-diisocyanato-diphenylmethane, and diisocyanatonaphthalene. Examples of triisocyanates include 1,3,5-triisocyanatobenzene, 2,4,6-triisocyanatotoluene, 1,8-diisocyanato-4-(isocyanatomethyl) octane, and lysine triisocyanate. Adducts and oligomers of polyisocyanates, for instance biurets, isocyanurates, allophanates, uretdiones, urethanes, and mixtures thereof are also included. Examples of such oligomers and adducts are the adduct of 2 molecules of a diisocyanate, for example hexamethylene diisocyanate or isophorone diisocyanate, to a diol such as ethylene glycol, the adduct of 3 molecules of hexamethylene diisocyanate to 1 molecule of water (available under the trademark Desmodur N of Bayer), the adduct of 1 molecule of trimethylol propane to 3 molecules of toluene diisocyanate (available under the trademark Desmodur L of Bayer), the adduct of 1 molecule of trimethylol propane to 3 molecules of isophorone diisocyanate, the adduct of 1 molecule of pentaerythritol to 4 molecules of toluene diisocyanate, the adduct of 3 moles of m-α,α,α′,α′-tetramethyl xylene diisocyanate to 1 mole of trimethylol propane, the isocyanurate trimer of 1,6-diisocyanatohexane, the isocyanurate trimer of isophorone diisocyanate, the uretdione dimer of 1,6-diisocyanatohexane, the biuret of 1,6-diisocyanatohexane, the allophanate of 1,6-diisocyanatohexane, and mixtures thereof. Furthermore, (co)polymers of isocyanate-functional monomers such as α,α′-dimethyl-m-isopropenyl benzyl isocyanate are suitable for use.

The thermal activator module comprises one or more components which exhibit an accelerating effect on the reaction between functional groups A and B of the mixture of the binder module and the crosslinker module. Depending on the nature of the functional groups and the type of active component in the activator module, the accelerating effect may be more pronounced at elevated temperature. However, the accelerating effect may also be present at ambient temperature. By thermal activator module it is meant that its irradiation with ultraviolet light has no substantial effect on the accelerating effect of the thermal activator module. In other words, after irradiation with ultraviolet light the components of the thermal activator module do not exhibit a greater accelerating effect on the reaction between functional groups A and B than before irradiation with ultraviolet light.

In one embodiment, the thermal activator module comprises a component which as such acts as a catalyst for the reaction between functional groups A and B. Examples of suitable catalysts are acids, bases, or metal based catalysts. Suitable metals in the metal based catalyst include zinc, cobalt, manganese, zirconium, bismuth, and tin. It is preferred that the coating composition comprises a tin based catalyst. Well-known examples of tin based catalysts are dimethyl tin dilaurate, dimethyl tin diversatate, dimethyl tin dioleate, dibutyl tin dilaurate, dioctyl tin dilaurate, and tin octoate.

Alternatively, the thermal activator module comprises a component which generates an active species upon heating. Peroxides which generate radicals upon heating may be mentioned as an example. In still another embodiment, the active component in the thermal activator module is not primarily in itself an active catalyst for the functional groups A and B, but activates a deactivated catalyst which may be present in the binder module or the crosslinker module. A specific example of this embodiment is a binder module comprising a polyol and a metal based catalyst as described above, which is deactivated by combination with a thiol-functional compound, and a thermal activator module which comprises a tertiary amine. Under the influence of the tertiary amine, the deactivated metal based catalyst can be activated.

The ultraviolet activator module comprises one or more components which after irradiation with ultraviolet light exhibit a greater accelerating effect on the reaction between functional groups A and B of the mixture of the binder module and the crosslinker module than before irradiation with ultraviolet light.

In one embodiment, the ultraviolet activator module comprises a component which after irradiation acts as a catalyst for the reaction between functional groups A and B. Examples of suitable catalysts are photolatent acids, photolatent bases, or photoactivatable metal based catalysts. Suitable metals in the metal based catalyst include zinc, cobalt, manganese, zirconium, bismuth, and tin.

In still another embodiment, the active component in the ultraviolet activator module is not primarily in itself an active catalyst for the functional groups A and B, but activates a deactivated catalyst which may be present in the binder module or the crosslinker module. A specific example of this embodiment is a binder module comprising a polyol and a metal based catalyst as described above, which is deactivated by combination with a thiol-functional compound, and a ultraviolet activator module which comprises a photolatent base. Upon irradiation of the coating composition, a base is generated, which in turn activates the deactivated metal based catalyst.

In one embodiment, activation of the photolatent base releases a base which has a pKa value which is at least one unit higher than the pKa value prior to activation. This leads to a particularly good balance of pot life of the coating composition and curing speed upon irradiation.

Suitable photolatent bases include N-substituted 4-(o-nitrophenyl) dihydropyridines, optionally substituted with alkyl ether and/or alkyl ester groups, and quaternary organo-boron photoinitiators. Examples of an N-substituted 4-(o-nitrophenyl) dihydropyridine are N-methyl nifedipine (Macromolecules 1998, 31, 4798), N-butyl nifedipine, N-butyl 2,6-dimethyl 4-(2-nitrophenyl) 1,4-dihydropyridine 3,5-dicarboxylic acid diethyl ester, and a nifedipine according to the following formula

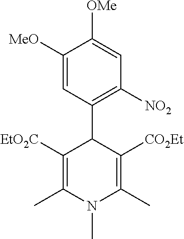 [SMILES: CCOC(=O)C1=C(C)N(C)C(C)=C(C(=O)OCC)C1c1cc(OC)c(OC)cc1[N+](=O)[O-]]

i.e. N-methyl 2,6-dimethyl 4-(4,5-dimethoxy-2-nitrophenyl) 1,4-dihydropyridine 3,5-dicarboxylic acid diethyl ester. Examples of quaternary organo-boron photoinitiators are disclosed in GB-A-2 307 473, such as

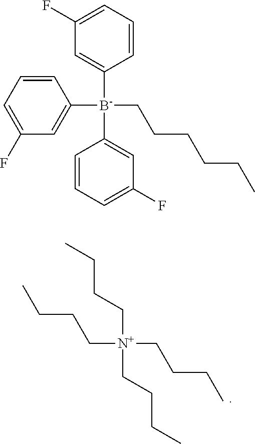

Thus far optimum results have been obtained with a photolatent base belonging to the group of α-amino acetophenones. Examples of α-amino acetophenones which can be used in the photoactivatable coating compositions according to the present invention are: 4-(methylthiobenzoyl)-1-methyl-1-morpholinoethane (Irgacure® 907 ex Ciba Specialty Chemicals) and (4-morpholinobenzoyl)-1-benzyl-1-dimethylamino propane (Irgacure® 369 ex Ciba Specialty Chemicals) disclosed in EP-A-0 898 202. Preferred is an α-amino acetophenone according to the following formula

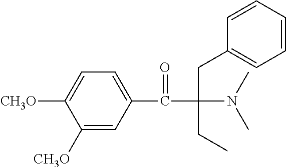

The invention also relates to a process of preparing a curable coating composition comprising the step of mixing the binder module a), the crosslinker module b), and at least one of modules c) or d) of the kit of parts.

The process allows the preparation of coating compositions which are curable thermally, or by ultraviolet light, or by a combination of these. The cure response to different triggers can be tuned by the relative amount of modules c) and/or d) which is added to the coating composition. This gives highly desired flexibility to the user of the coating composition.

The invention further relates to process of coating a substrate comprising
a) preparing a curable coating composition by mixing modules a), b), and at least one of modules c) or d) of the kit of parts according to the invention,
b) applying the coating composition to a substrate, and
c) curing the coating composition.

The modules are usually liquid and mixing can suitably be carried out by stirring the components together in a suitable container. The modules are generally provided in separate packs, which may be grouped together to simplify logistics. It is also possible to provide the binder module and the crosslinker module in the packs which contain the required stoichiometric amounts of binder and crosslinker. This can help to eliminate mixing and metering errors during preparation of the coating composition.

The coating composition can be applied to any substrate. Application can be carried out by any method which is suitable for applying liquid coating compositions, such as brushing, rolling, dipping, or spraying. The substrate may be, for example, metal, e.g., iron, steel, and aluminium, plastic, wood, glass, synthetic material, paper, leather, or another coating layer. The coating compositions show particular utility as clear coats, base coats, pigmented top coats, primers, and fillers. When the coating composition is a clear coat composition, it is preferably applied over a colour- and/or effect-imparting base coat. In that case, the clear coat forms the top layer of a multi-layer lacquer coating such as typically applied on the exterior of automobiles. The base coat may be a water borne base coat or a solvent borne base coat. The coating compositions are suitable for coating objects such as bridges, pipelines, industrial plants or buildings, oil and gas installations, or ships. The compositions are particularly suitable for finishing and refinishing automobiles and large transportation vehicles, such as trains, trucks, buses, and airplanes.

When the coating composition comprises modules c) and/or d), curing of the coating composition can be carried out thermally. The thermal cure step is suitably carried out at a temperature between 10° C. and 80° C. The preferred temperature is between 20° C. and 60° C., for example 25° C., or 40° C.

In one embodiment, the thermal curing step is carried out at ambient temperature without active supply of heat. Alternatively, the thermal cure step may be carried out at least partially in a heating chamber wherein heat is supplied by hot air or by convection. In a further embodiment, the thermal cure step is supported by irradiation with infrared radiation. Any commercial infrared irradiation device can be used, for example devices emitting short- or medium-wavelength infrared radiation. When the coating composition comprises module d), curing can be initiated by ultraviolet radiation. Curing of the coating can be initiated by exposing the coating composition to ultraviolet radiation prior to, during, or after application to a substrate. Exposure to ultraviolet radiation prior to application to a substrate can, for example, be carried out by exposure of the ready-to-spray coating composition to ultraviolet radiation. In one embodiment, an ultraviolet lamp may be immersed in the liquid coating composition. Alternatively, the coating composition in a container is exposed to ultraviolet radiation from an external source, such as a UV cabinet. After activation by ultraviolet light, the viscosity of the activated coating composition starts to increase. However, there is a relatively long period during which the activated coating composition can be applied, for example 1 hour, without deterioration of the final coating properties. Irradiation prior to application avoids the problems which are caused by three-dimensionally shaped substrates. A known problem with such substrates is the presence of shadow areas in UV curing processes, when radiation has to be carried out after application of the coating to a substrate.

An additional advantage of irradiation prior to application is that the container with the coating composition can be irradiated safely in a closed UV light-cabinet without the risk of persons being exposed to harmful ultraviolet radiation. Even the high energy UV B or UV C radiation can be used safely.

Irradiation of the coating composition prior to application is particularly suitable for clear coat compositions.

For exposure to ultraviolet light during application use may be made of a special spray gun which allows irradiation of the spray mist with ultraviolet radiation during spraying. Suitable spray guns for such a process are described in International patent application WO 2004/69427 A. For exposure to ultraviolet radiation after application use may be made of known ultraviolet curing devices, for example hand-held lamps. The exposure to ultraviolet radiation may take place directly after application, i.e. without an intermediate flash-off or evaporation phase. Alternatively, irradiation may be carried out after an intermediate flash-off or evaporation phase. It is also possible to carry out the ultraviolet radiation in more than one phase, for example
prior to and during application to a substrate,
prior to and after application to a substrate,
prior to, during, and after application to a substrate, and
during and after application to a substrate.

In all embodiments ultraviolet radiation sources which may be used are those customary for UV, such as high- and medium-pressure mercury lamps. In order to avoid any risk involved in handling UV light of very short wavelength (UV B and/or UV C light), preference is given, especially for use in automotive refinishing shops, to fluorescent lamps which produce the less injurious UV A light. UV light-emitting diodes (UV-LEDs) can likewise be used. Typical exposure times to ultraviolet radiation are 5 to 400 seconds, or 20 to 100 seconds, or 30 to 80 seconds.

### EXAMPLES

Abbreviations and raw materials used:
BYK 331 solution A mixture consisting of 10 weight-% of BYK 331, a silicone additive ex BYK Chemie, and 90 weight-% of n-butyl acetate
DOTL solution A mixture consisting of 10 weight-% of dioctyl tin dilaurate and 90 weight-% of n-butyl acetate
PTMP Pentaerythritol (tetrakis) 3-mercaptopropionate
Tolonate HDT LV Isocyanurate trimer of hexamethylene diisocyanate ex Rhodia
PAPO Polyacrylate polyol as described in Example AB of WO 2007/020269, but without methacrylic acid and styrene, subjected to an after-treatment with the glycidyl ester of versatic acid, acid value is 0.4 mg KOH/g
Tinuvin 292 Mixture of bis(1,2,2,6,6-pentamethyl-4-piperidinyl)-sebacate and 1-(Methyl)-8-(1,2,2,6,6-pentamethyl-4-piperidinyl)-sebacate ex Ciba

### Preparation of a polyester polyol (PEPO)

In a reaction vessel equipped with a stirrer, a heating system, a thermocouple, a packed column, a condenser, and a water separator were placed 440 parts by weight of trimethylol propane, 170 parts by weight of hexahydrophthalic anhydride, and 390 parts by weight of Edenor V85 (short chain fatty acid mixture ex Cognis). Furthermore, an amount of 1 weight-%, calculated on the building blocks, of 85 weight-% aqueous phosphoric acid was added as catalyst. Under inert gas the temperature was increased gradually to 240° C. The reaction water was distilled off at such a rate that the temperature at the top of the column did not exceed 102° C. The reaction was continued until a polyester having a hydroxyl value of 306 mg KOH/g was obtained. The acid value was 3 mg KOH/g.

Clear coat compositions 1 and 2 according to the invention were prepared by mixing the following components, the amounts are given in parts by weight.

TABLE 1
Clear Coat Compositions

| | 1 | 2 |
|---|---|---|
| Binder Module | | |
| PEPO | 28.73 | 28.73 |
| PAPO | 26.17 | 26.17 |
| DOTL solution | 5.10 | 5.10 |
| BYK 331 solution | 1.00 | 1.00 |
| PTMP | 1.30 | 1.30 |
| Crosslinker Module | | |
| Tolonate HDT LV | 44.65 | 44.65 |
| n-Butyl acetate | 30.00 | 30.00 |
| Thermal Activator Module | | |
| Tinuvin 292 | 0.50 | 0.50 |
| n-Butyl acetate | 10.00 | 10.00 |
| Ultraviolet Activator Module | | |
| 2-Benzyl-1-(3,4-dimethoxy-phenyl)-2-dimethylamino-1- | | 0.50 |
| one (a photolatent base) | | |
| Xylene | | 4.50 |

The compositions of Examples 1 and 2 both had a VOC of 370 g/l and a viscosity (DIN4 cup, s) of 15.0.

The clear coat compositions were applied onto coil-coated Al panels (7×25 cm). Two layers of clear coat were sprayed with a DeVilbiss GTI 1.3 gun (pressure=2.5-2.7 bar) with 2 minutes flash-off in between.

The viscosity development of the clear coats was measured with a DIN-cup 4 (DC4 Viscotimer) and is indicated in seconds. The measurements were carried out at 22° C. and 50% relative humidity. The pot life is defined as the period of time in which the initial viscosity after mixing has doubled.

The results of the viscosity measurements are summarized below in Table 2.

TABLE 2
Viscosity Development of Clear Coat Compositions

Viscosity (s)

| Time (min) | Exp. 1 | Exp. 2 |
|---|---|---|
| 0 | 15.5 | 15.7 |
| 5 | 15.5 | 15.7 |
| 10 | 15.4 | 15.5 |
| 20 | 15.5 | 15.8 |
| 30 | 15.6 | 15.9 |
| 60 | 15.8 | 15.8 |
| 120 | 16.0 | 15.7 |

The clear coat compositions of Examples 1 and 2 show virtually no viscosity increase, even after two hours.

The coating compositions provide a good balance of low content of volatile organic solvents at application viscosity (VOC≈370 g/l) and long pot life, a fast drying rate at room temperature and slightly elevated temperatures, low susceptibility to foam stabilization in the drying coating, and good appearance properties. In addition, the coating provides properties required for motor vehicle exterior finishes, such as good hardness and scratch resistance, gloss, durability, and resistance to chemicals and UV radiation.

The touch dry times of clear coats from Examples 1 and 2 were determined manually under various conditions:
At room temperature (RT), 40° C. and 60° C. (heated oven)
Under IR radiation
1 min irradiation with a UV-A followed by RT, 40° C. and 60° C.
1 min irradiation with a UV-A followed by IR radiation
Continuous irradiation under UV-A lamp

TABLE 3
Drying Data.

| | Drying Time to touch dry (minutes) | | | | | | | | |
|---|---|---|---|---|---|---|---|---|---|
| | | | | | | UV-A + | UV-A + | UV-A + | UV-A |
| Exp. | RT | 40° C. | 60° C. | IR | UV-A + RT | 40° C. | 60° C. | IR | Lamp |
| 1 | 50 | 30 | 15 | 10 | — | — | — | | — |
| 2 | — | — | — | — | 20 | 15 | 6 | 4 | 15 |

It is clear from these results that the clear coat of Example 2, containing also the UV activator module, is activated under UV light causing an increased drying speed at all temperatures. The coatings can be cured very effectively at room temperature and at slightly elevated temperatures, using or combining various drying methods.

### Properties of the Coating

Clear coat compositions were spray-applied by a coating robot or manually on metal panels that were pre-coated with a primer and a basecoat layer.

The clear coats were applied with a layer thickness gradient (50-100 μm). After a flash-off period the samples were photo-activated by the UV-A source and allowed to fully cure at various temperatures.

After cure, the number of pinholes was counted in an area of 4 cm² at a clear coat layer thickness of 80 μm.

Enamel hold out (EHO) was determined visually in order to judge the general appearance. The following aspects were taken into consideration: gloss, wrinkling, flow, and image clarity/distinctness of image. These aspects were combined into one score on a 1-10 scale (very bad appearance=1, excellent appearance=10).

The Persoz Hardness of the samples was determined 2 hours after curing, and after 1 day. The results are indicated in seconds.

The warm tackiness was determined manually by pressing a finger on the warm coating surface after curing. The results are reported in Table 4 on a scale from 1 to 10 (very bad=1, excellent=10).

TABLE 4
Properties of dried films.

Exp.

| Properties | 1 | 2 |
|---|---|---|
| Pinholes | 0 | 0 |
| EHO | 8 | 9 |
| Persoz Hardness directly after curing (sec) | 36 | 22 |
| Persoz Hardness 1 day (sec) | 95 | 86 |
| Warm tackiness | 9 | 8 |

1-7. (canceled)

8. A kit of parts for preparation of a crosslinkable coating composition comprising:
a) a binder module comprising a film-forming binder comprising crosslinkable functional groups A, wherein the functional groups A are hydroxyl groups, wherein the binder module a) further comprises a deactivated metal-based catalyst;
b) a crosslinker module comprising a crosslinker comprising at least two functional groups B capable of reacting with the crosslinkable functional groups A of the binder, and wherein the functional groups A and B are not the same, wherein the functional groups B are isocyanate groups;
c) a thermal activator module comprising one or more components which, optionally upon heating, exhibit an accelerating effect on the reaction between functional groups A and B of the mixture of the binder module and the crosslinker module, and which after irradiation with ultraviolet light do not exhibit a greater accelerating effect on the reaction between functional groups A and B than before irradiation with ultraviolet light, and wherein the thermal activator module comprises a tertiary amine; and
d) an ultraviolet activator module comprising one or more components which after irradiation with ultraviolet light exhibit a greater accelerating effect on the reaction between functional groups A and B of the mixture of the binder module and the crosslinker module than before irradiation with ultraviolet light.

9. The kit of parts according to claim 8, wherein the ultraviolet activator module comprises a photolatent base.

10. A process of preparing a curable coating composition comprising the step of mixing modules a), b), and at least one of modules c) and d) of the kit of parts according to claim 8.

11. A process of preparing a curable coating composition comprising the step of mixing modules a), b), and at least one of modules c) and d) of the kit of parts according to claim 9.

12. A process of coating a substrate comprising:
a) preparing a curable coating composition by mixing modules a), b), and at least one of modules c) and d) of the kit of parts according to claim 8;
b) applying the curable coating composition to a substrate; and
c) curing the curable coating composition.

13. A process of coating a substrate comprising:
a) preparing a curable coating composition by mixing modules a), b), and at least one of modules c) and d) of the kit of parts according to claim 9;
b) applying the curable coating composition to a substrate; and
c) curing the curable coating composition.
